(19) United States
(12) Patent Application Publication
(10) Pub. No.: US 2022/0216987 A1
(43) Pub. Date: Jul. 7, 2022

(54) DEVICE AND METHOD FOR MANAGING SHARED DIGITAL KEY

(71) Applicant: Samsung Electronics Co., Ltd., Suwon-si, Gyeonggi-do (KR)

(72) Inventors: Taehyung LIM, Suwon-si (KR); Inyoung SHIN, Suwon-si (KR); Duckey LEE, Suwon-si (KR); Jonghyo LEE, Suwon-si (KR); Sooyeon JUNG, Suwon-si (KR)

(21) Appl. No.: 17/423,643

(22) PCT Filed: Dec. 17, 2019
(86) PCT No.: PCT/KR2019/017889

§ 371 Date: Jul. 16, 2021

(30) Foreign Application Priority Data
Jan. 17, 2019 (KR) 10-2019-0006295

(51) Int. Cl. H04L 9/08; H04W 4/80

(52) U.S. Cl. CPC H04L 9/0838; H04L 9/0827; H04L 2209/80; H04W 4/80; H04L 9/088

(57) ABSTRACT

The present disclosure relates to a method of managing a shared digital key. An operating method of an electronic device for managing a digital key, according to various embodiments of the present disclosure, includes: receiving a response message to a request message for managing a shared digital key; verifying information included in the received response message; and managing the shared digital key based on the verified information.

### TECHNICAL FIELD

The present disclosure relates to a device and method for managing a shared digital key.

### BACKGROUND ART

As personalized electronic devices, such as smartphones and tablet personal computers (PCs), become popular, technologies for performing security, authentication, and the like using a digitized virtual key (i.e. , digital key) are under development. As one of such digital key technologies, a technology of integrating a digital key into a mobile device, for example, a smartphone by using a wireless communication technology such near field communication (NFC) is being developed.

By inserting a digital key into a mobile device, a user of the mobile device may open and close a door by using the digital key, in replacement of a physical key. In addition, as the function of the digital key is further expanded, the user of the mobile device may use the digital key to access and control the mobile device.

The use of digital keys may bring great improvements in user convenience and industrial effectiveness, but security concerns are also raised. Due to the nature of digital keys that require connection with electronic devices, the electronic devices may be exposed to risks such as hacking. Therefore, it is necessary to manage digital keys in a high-security area.

### DESCRIPTION OF EMBODIMENTS

### Technical Problem

Various embodiments of the present disclosure provide a device and method for managing a shared digital key.

### Solution to Problem

According to various embodiments of the present disclosure, an operating method of an electronic device for managing a digital key includes: receiving a response message to a request message for managing a shared digital key; verifying information included in the received response message; and managing the shared digital key based on the verified information.

According to various embodiments of the present disclosure, an operating method of a target device includes: verifying information included in a request message for managing a shared digital key; generating a response message to the request message based on the verified information; and transmitting the generated response message.

According to various embodiments of the present disclosure, an electronic device includes: a communicator configured to receive a response message to a request message for managing a shared digital key; and at least one processor configured to verify information included in the received response message and manage the shared digital key based on the verified information.

### BRIEF DESCRIPTION OF DRAWINGS

FIG. 1 is a diagram for describing an environment to which a digital key is applied, according to various embodiments of the present disclosure.

FIG. 2 is a diagram for describing a system for implementing a service by using a digital key, according to various embodiments of the present disclosure.

FIG. 3 is a sequence diagram for schematically describing a method of managing a shared digital key, according to various embodiments of the present disclosure.

FIG. 4 illustrates an example of information included in a request message and a response message, according to various embodiments of the present disclosure.

FIG. 5 is a flowchart of an operating process of an electronic device, according to various embodiments of the present disclosure.

FIG. 6 is a flowchart of an operating process of a target device, according to various embodiments of the present disclosure.

FIG. 7 is a sequence diagram for schematically describing a digital key management method initiated or triggered by an electronic device, according to various embodiments of the present disclosure.

FIG. 8 is a sequence diagram for schematically describing a digital key management method initiated or triggered by a target device, according to various embodiments of the present disclosure.

FIG. 9 is a sequence diagram for schematically describing a digital key management method initiated or triggered by a first backend server, according to various embodiments of the present disclosure.

FIG. 10 is a sequence diagram for schematically describing a digital key management method initiated or triggered by a second backend server, according to various embodiments of the present disclosure.

FIG. 11 is a diagram illustrating a configuration of an electronic device, according to various embodiments of the present disclosure.

FIG. 12 is a diagram illustrating a configuration of a target device, according to various embodiments of the present disclosure.

FIG. 13 is a diagram illustrating a configuration of a secure element, according to various embodiments of the present disclosure.

### BEST MODE

According to various embodiments of the present disclosure, an operating method of an electronic device for managing a digital key includes: receiving a response message to a request message for managing a shared digital key; verifying information included in the received response message; and managing the shared digital key based on the verified information.

### Mode of Disclosure

Hereinafter, embodiments of the present disclosure will be described in detail with reference to the accompanying drawings so that the present disclosure may be easily carried out by those of ordinary skill in the art. However, the present disclosure may be embodied in many different forms and is not limited to the embodiments of the present disclosure described herein. Also, in order to clearly describe the present disclosure, parts having no relation to the description are omitted, and like reference numerals are assigned to like elements throughout the specification.

Some embodiments of the present disclosure may be represented by functional block configurations and various processing steps. All or part of these functional blocks may be implemented in various numbers of hardware and/or software configurations that perform specific functions. For example, the functional blocks of the present disclosure may be implemented by one or more microprocessors, or may be implemented by circuit configurations for certain functions. Also, for example, the functional blocks of the present disclosure may be implemented in various programming or scripting languages. The functional blocks may be implemented as an algorithm that is executed on one or more processors. Also, the present disclosure may employ the related art for electronic configuration, signal processing, and/or data processing.

In addition, connecting lines or connecting members between elements illustrated in the drawings only exemplify functional connections and/or physical or circuit connections. In an actual device, a connection between elements may be represented by various functional connections, physical connections, or circuit connections that are replaceable or added.

Hereinafter, the present disclosure will be described in detail with reference to the accompanying drawings.

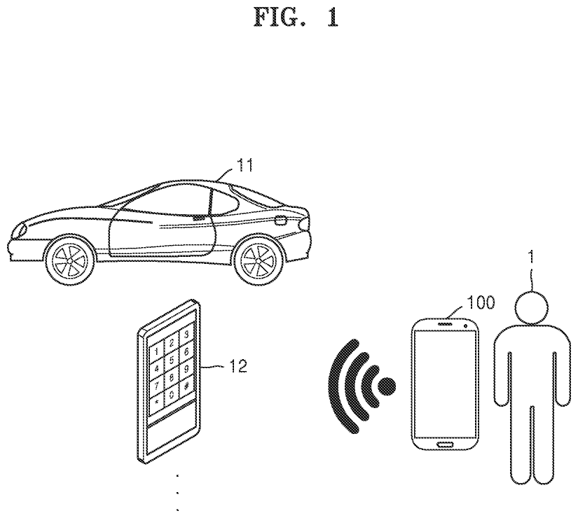

FIG. 1 is a diagram for describing an environment to which a digital key is applied, according to various embodiments of the present disclosure.

Referring to FIG. 1, an owner device 100, a user 1 of the owner device 100, and electronic devices 11, 12, . . . for performing access and control by using a digital key stored in the owner device 100 is disclosed. In various embodiments, the user 1 who uses the owner device 100 may be referred to as an owner.

The owner device 100 may include a personalized mobile device, but the present disclosure is not limited thereto. The owner device 100 may include various types of electronic devices. For example, the owner device 100 may include a smartphone, a tablet personal computer (PC), a PC, a camera, and a wearable device. The owner device 100 may perform a process of accessing the electronic devices 11, 12, . . . and generating, deleting, and managing digital keys for controlling the electronic devices 11, 12, . . . , and may perform authentication on the digital keys.

The electronic devices 11, 12, . . . may interoperate with the owner device 100 to perform an operation for generating the digital keys, and may be controlled and accessed by using the digital keys.

As an example, the owner device 100 may store a digital key for interoperating with the electronic device 11 mounted on an automobile. The owner device 100 may control various operations of the automobile by using the stored digital key. For example, the owner device 100 may use the digital key to open and close a door of the automobile, start an engine, and control various devices mounted on the automobile. Furthermore, the owner device 100 may also control an operation related to autonomous driving, such as an automatic parking system.

As another example, the owner device 100 may store a digital key for interoperating with a doorlock 12. The owner device 100 may open and close a door by using the stored digital key.

The electronic device that the owner device 100 may control by using the digital key is not limited to the example illustrated in FIG. 1, and the digital key technology may be applied to various electronic devices. Hereinafter, for convenience of description, a case in which the owner device 100 interoperates with the electronic device 11 mounted on the automobile will be described as an example. However, the following description may also be applied to a case in which the owner device 100 interoperates with various electronic devices other than the electronic device 11 mounted on the automobile.

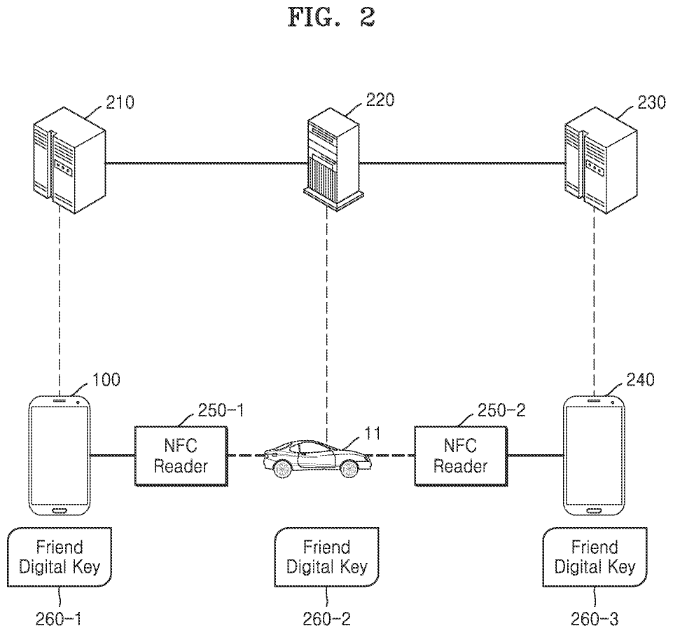

FIG. 2 is a diagram for describing a system for implementing a service by using a digital key, according to various embodiments of the present disclosure.

Referring to FIG. 2, an owner device backend server 210, a target device backend server 220, a backend server 230 for an electronic device of another user, an owner device 100, a first near field communication (NFC) reader 250-1, an electronic device 11, a second NFC reader 250-2, an electronic device 240 of another user, and digital keys 260-1, 260-2, and 260-3 of another user are illustrated. In various embodiments of the present disclosure, the electronic device 11 may be referred to as a target device 11.

Although not illustrated in FIG. 2, a service provider server is a server that is operated by a service provider which provides a digital key service to a user. The service provider refers to a business operator that provides services related to, for example, automobile, hotels, houses, buildings, and the like, and may provide a digital key service to a user as an additional service based on a main service. For example, an automobile company sells automobiles, and a hotel, house, or building company provides services related to hotels, houses, or buildings. For example, the service provider server may be operated by an automobile company. For example, the service provider server may provide a digital key service for an access function such as door opening and closing, engine start, and control.

The service provider server may include a user information database that stores user account information such as user identifier (ID) and password, selling product, or service information. For example, when an automobile company sells an automobile, the service provider server may store information about user ID, password, identification number of the sold automobile, and use or non-use of a digital key service.

The owner device backend server (or backend server) 210 provides a technology and service capable of securely issuing a digital key to the owner device 100 and storing the digital key. The owner device backend server 210 may be, for example, a server that is operated by a manufacturer (original equipment manufacturer (OEM)) of the owner device 100, a server that is operated by a telecommunications company that provides a mobile communication service, or a server that is operated by a service provider that provides a digital key service.

For example, when the user 1 purchases an automobile and stores a digital key of the automobile on the owner device 100, the owner device 100 may perform an authentication procedure. For example, the owner device 100 may perform an authentication procedure to check whether the user 1 is a valid user, the automobile is a valid automobile, and the like. The owner device backend server 210 may support such an authentication procedure.

The target device backend server 220 may provide a digital key service related to the target device. For example, the target device backend server 220 may provide a digital key service for an access function such as door opening and closing, engine start, and control. In an embodiment, the target device backend server 220 may be a server that is operated by a service provider which provides a digital key service to a user. More specifically, the target device backend server 220 may be a server that is operated by a manufacturer of the target device 11. The service provider may refer to a business operator that provides services related to, for example, automobile, hotels, houses, buildings, and the like, and may provide a digital key service to a user as an additional service based on a main service. For example, when an automobile company sells automobiles and a hotel, house, or building company provides services related to hotels, houses, or buildings, the target device backend server 220 may be operated by the automobile company or the hotel, house, or building company.

In an embodiment, the target device backend server 220 may include a user information database that stores user account information such as user ID and password, selling product, or service information. For example, when an automobile company sells an automobile, the target device backend server 220 may store information about user ID, password, identification number of the sold automobile, and use or non-use of a digital key service.

In an embodiment, the target device backend server 220 may transmit information for the digital key service to the owner device backend server 210 in order to provide the digital key service to the user. In addition, the target device backend server 220 may transmit information for the digital key service to the backend server 230 for the electronic device of another user in order to provide the digital key service to another user (e.g. , a friend).

The backend server 230 for the electronic device of another user may be a server that is operated by a manufacturer of the electronic device 240 of another user (e.g. , a friend) other than an owner. The manufacturer of the owner device 100 may be identical to or different from the manufacturer of the electronic device 240 of another user (e.g. , a friend).

The electronic device 11 is an entity corresponding to a product and a service that the service provider sells to the user. For example, the electronic device 11 may include a gate of an automobile, a hotel, a house, a building, or the like. More specifically, the electronic device 11 may include not only a vehicle door, a trunk gate, and an oil filling port in an automobile, but also an access gate for engine start and vehicle control.

In various embodiments of the present disclosure, the owner device 100, the target device 11, and the electronic device 240 of another user may share the digital key of another user. For example, the owner device may store a digital key 260-1 of another user, the target device may store a digital key 260-2 of another user, and another user may store his or her digital key 260-3. In various embodiments, the owner device 100 may manage the target device 11 and the digital key through the first NFC reader 250-1. The electronic device 240 of another user may manage the target device 11 and the digital key through the second NFC reader 250-2.

A method of managing a digital key shared between devices when the digital key of another user is shared by the owner device 100, the target device 11, and the electronic device 240 of another user, according to various embodiments of the present disclosure, will be described. That is, a method of managing the digital key 260-2 of another user stored in the target device 11, according to various embodiments of the present disclosure, will be described. In this case, the management of the shared digital key may refer to revocation or updating of the shared digital key. In various embodiments, the above-described management of the shared digital key may be requested by the user 1 (e.g. , the owner) or another user (e.g. , the friend). In various embodiments, the above-described management of the shared digital key may be initiated or triggered by the owner device 100, the electronic device 240 of another user, the target device 11, the owner device backend server 210, the backend server 230 for the electronic device of another user, or the target device backend server 220. In various embodiments of the present disclosure, initiating or triggering may mean that the management of the shared digital key is started.

In various embodiments of the present disclosure, the user 1 (e.g. , the owner) or another user (e.g. , the friend) may make a request to revoke the digital key 260-2 of another user stored in the target device 11. In this case, the operation of revoking the digital key 260-2 of another user may be initiated or triggered by the owner device 100, the electronic device 240 of another user, the target device 11, the owner device backend server 210, the backend server 230 for the electronic device of another user, or the target device backend server 220. In various embodiments, the revoking of the shared digital key may refer to revocation of the permission to share the digital key shared with another user.

In various embodiments of the present disclosure, the user 1 (e.g. , the owner) may make a request to update the digital key 260-2 of another user stored in the target device 11. In this case, the operation of updating the digital key 260-2 of another user may be initiated or triggered by the owner device 100, the target device 11, the owner device backend server 210, or the target device backend server 220. In various embodiments, the updating of the shared digital key may refer to changing information about an expiration date of the digital key shared with another user or the permission to use the digital key shared with another user. In an embodiment, the permission to use the shared digital key may refer to permission to open and close an automobile door, to open and close a trunk door, or to start an automobile. In an embodiment, an update request other than the permission to use the shared digital key may be requested by another user (e.g. , the friend). However, the present disclosure may be implemented in various different forms, and is not limited to the embodiments described herein. Hereinafter, a method of managing a pre-shared digital key will be described.

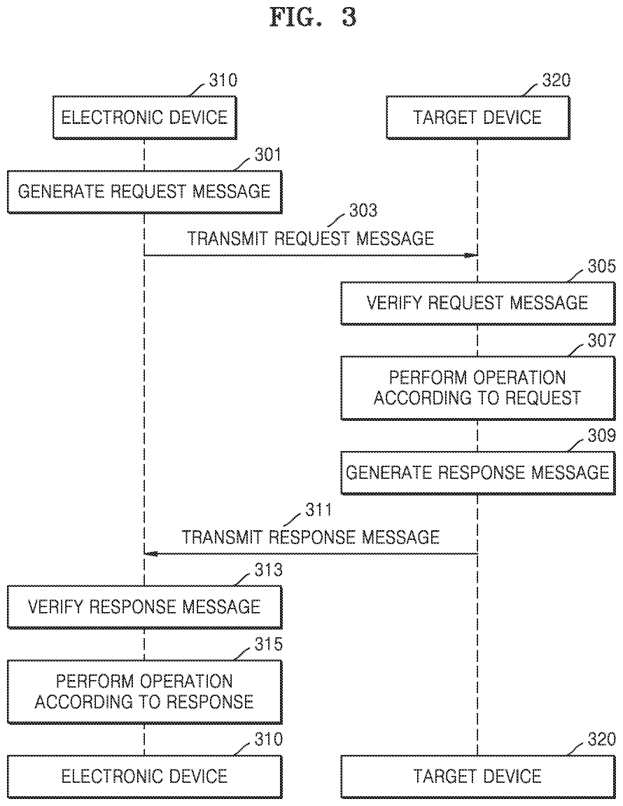

FIG. 3 is a sequence diagram for schematically describing a method of managing a shared digital key, according to various embodiments of the present disclosure.

Referring to FIG. 3, an electronic device 310 may refer to the owner device 100 or the electronic device 240 of another user. A target device 320 may refer to the electronic device 11. For example, the electronic device 11 may refer to an automobile or an electronic device mounted on the automobile. In various embodiments, the electronic device 310 may be referred to as an initiator.

In operation 301, the electronic device 310 may generate a request message. For example, the electronic device 310 may generate a message requesting management of a shared digital key. In various embodiments, the request message may include information about the shared digital key, request information, routing information, or a signature of a sender who has transmitted the request message. For example, the signature of the sender may refer to a signature of a user of the electronic device 310.

In operation 303, the electronic device 310 may transmit the request message. For example, the electronic device 310 may transmit the generated request message to the target device 320.

In operation 305, the target device 320 may verify the received request message.27388387118362 For example, the target device 320 may verify information about the shared digital key, request information, or a signature of a sender transmitting the request message, which is included in the received request message.

In operation 307, the target device 320 may perform an operation according to the request. That is, the target device 320 may perform shared digital key management based on the information included in the request message. For example, when the request information of the request message includes information related to the revocation of the shared digital key, the target device 320 may revoke the shared digital key stored in the target device 320. When the request information of the request message includes information related to the updating of the shared digital key, the target device 320 may update the shared digital key stored in the target device 320.

In operation 309, the target device 320 may generate a response message. In various embodiments, the response message may include information about the shared digital key, response information, routing information, or a signature of a sender transmitting the response message. For example, the signature of the sender may refer to a signature of a user of the target device 320.

In operation 311, the target device 320 may transmit the response message. For example, the target device 320 may transmit the generated response message to the electronic device 310.

In operation 313, the electronic device 310 may verify the response message. For example, the electronic device 310 may verify information about the shared digital key, response information, or a signature of a sender transmitting the response message, which is included in the response message.

In operation 315, the electronic device 310 may perform an operation according to the response. For example, when the response information of the response message includes information related to the revocation of the shared digital key, the electronic device 310 may revoke the shared digital key stored in the electronic device 310. When the response information of the response message includes information related to the updating of the shared digital key, the electronic device 310 may update the shared digital key stored in the electronic device 310.

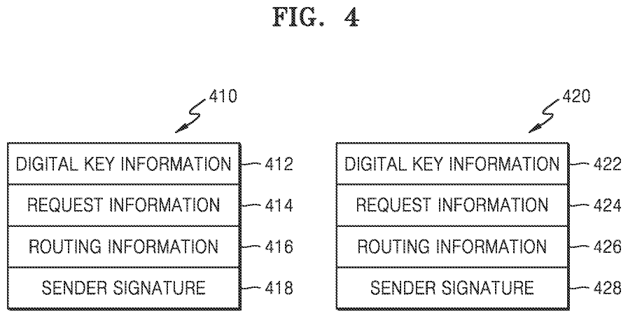

Through the above-described operations, the electronic device 310 and the target device 320 may manage the shared digital key of another user. The meaning of the information included in the request message and the response message will be described in detail with reference to FIG. 4.

FIG. 4 illustrates an example of the information included in the request message and the response message, according to various embodiments of the present disclosure.

Referring to FIG. 4, the request message 410 may include digital key information 412, request information 414, routing information 416, and a sender signature 418. The response message 420 may include digital key information 422, response information 424, routing information 426, and a sender signature 428.

In various embodiments, the digital key information included in the request message 410 may include information related to a shared digital key. For example, the digital key information may include a unique ID of the shared digital key. The unique identifier may distinguish the shared digital key from other digital keys.

In various embodiments, the request information 414 included in the request message 410 may refer to information requesting the management of the shared digital key. For example, the management of the shared digital key may refer to revocation or updating of the shared digital key. In an embodiment, the request information may include data (revocation request) for revoking the shared digital key. In another embodiment, the request information may include data (update request) for updating the shared digital key. Although the revocation or updating of the digital key is described as an example of the method of managing the digital key, the present disclosure is not limited thereto.

In various embodiments, the routing information 416 included in the request message 410 may include information related to a transmission path of the request message 410. For example, the routing information 416 may include an address for a destination to which the request message 410 is to be transmitted. In an embodiment, the address for the destination to which the request message 410 is to be transmitted may refer to a packet address to which a data packet is to be transmitted.

In various embodiments, the sender signature 418 included in the request message 410 may include information related to the signature of the sender who has transmitted the request message. For example, when the request message 410 is transmitted from the electronic device 310, the sender signature 418 may refer to a signature of a user of the electronic device 310. In various embodiments, the device receiving the request message 410 may verify, through the sender signature 418 included in the request message 410, whether the request message 410 has been transmitted by a correct sender.

In various embodiments, the digital key information included in the response message 420 may include information related to a shared digital key. For example, the digital key information may include a unique ID of the shared digital key. The unique identifier may distinguish the shared digital key from other digital keys.

In various embodiments, the response information 424 included in the response message 420 may refer to information requesting the management of the shared digital key. For example, a response to the management of the shared digital key may refer to a result of revoking or updating the shared digital key. That is, when the request information 414 included in the request message 410 indicates the revocation of the shared digital key, the target device 320 may revoke the shared digital key and include a result thereof in the response information 424. That is, when the request information 414 included in the request message 410 indicates the updating of the shared digital key, the target device 320 may update the shared digital key and include a result thereof in the response information 424.

In an embodiment, the response information 424 may include data (revocation_attestation) indicating a result of revoking the shared digital key. In another embodiment, the response information 424 may include data (update_confirmation) indicating a result of updating the shared digital key. Although the revocation or updating of the digital key is described as the method of managing the digital key, the present disclosure is not limited thereto.

In various embodiments, the routing information 426 included in the response message 420 may include information related to a transmission path of the response message 420. For example, the routing information 426 may include an address for a destination to which the response message 420 is to be transmitted. In an embodiment, the address for the destination to which the response message 420 is to be transmitted may refer to a packet address to which a data packet is to be transmitted.

In various embodiments, the sender signature 428 included in the response message 420 may include information related to the signature of the sender who has transmitted the response message. For example, when the response message 420 is transmitted from the target device 320, the sender signature 428 may refer to a signature of a user of the target device 320. In various embodiments, the device receiving the response message 420 may verify, through the sender signature 428 included in the response message 420, whether the response message 420 has been transmitted by a correct sender. Although it has been described that the request message 410 may include the digital key information 412, the request information 414, the routing information 416, and the sender signature 418, and the response message 420 may include the digital key information 422, the response information 424, the routing information 426, and the sender signature 428, the present disclosure is not limited thereto.

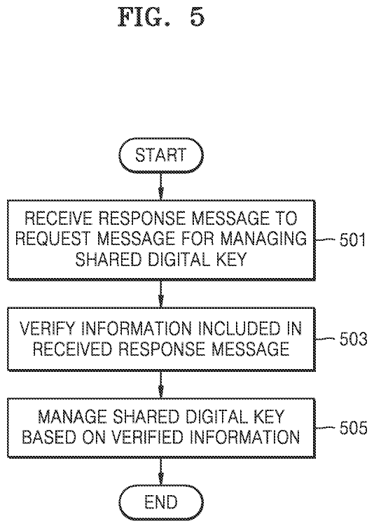

FIG. 5 is a flowchart of the operating process of the electronic device, according to various embodiments of the present disclosure. Hereinafter, the electronic device 310 may refer to the owner device 100 or the electronic device 240 of another user. In addition, the first backend server may refer to the backend server of the electronic device 310, and the second backend server may refer to the backend server of the target device 320. The backend server of the electronic device 310 may refer to the backend server 210 of the owner device or the backend server 230 for the electronic device of another user.

Referring to FIG. 5, in operation 501, the electronic device 310 may receive a response message to a request message for managing a shared digital key. Although not illustrated in FIG. 5, in an embodiment, when the management of the shared digital key is initiated or triggered by the electronic device 310, the electronic device 310 may generate the request message for managing the shared digital key and transmit the generated request message to the target device 320. In another embodiment, when the management of the shared digital key is initiated or triggered by the target device 320, the operation, performed by the electronic device 310, of generating and transmitting the request message may be omitted. In another embodiment, when the management of the shared digital key is initiated or triggered by the first backend server, the first backend server may generate the request message. In another embodiment, when the management of the shared digital key is initiated or triggered by the second backend server, the second backend server may generate the request message. After that, the electronic device 310 may receive a response message to the request message for managing the shared digital key.

In operation 503, the electronic device 310 may verify information included in the received response message. For example, the received response message may include at least one of digital key information, response information, routing information, or a sender signature. In various embodiments, the response information may refer to a response to the management of the shared digital key. For example, the response to the management of the shared digital key may refer to a result of revoking or updating the shared digital key. Also, the electronic device 310 may verify, through the sender signature, whether the response message has been transmitted by a correct sender.

In operation 505, the electronic device 310 may manage the shared digital key based on the verified information. For example, when it is verified that the response information of the response message includes information related to the revocation of the shared digital key, the electronic device 310 may revoke the shared digital key stored in the electronic device 310. When it is verified that the response information of the response message includes information related to the updating of the shared digital key, the electronic device 310 may update the shared digital key stored in the electronic device 310. As the method of managing the shared digital key, the revocation or updating of the shared digital key is described in operation 505, but the present disclosure is not limited thereto.

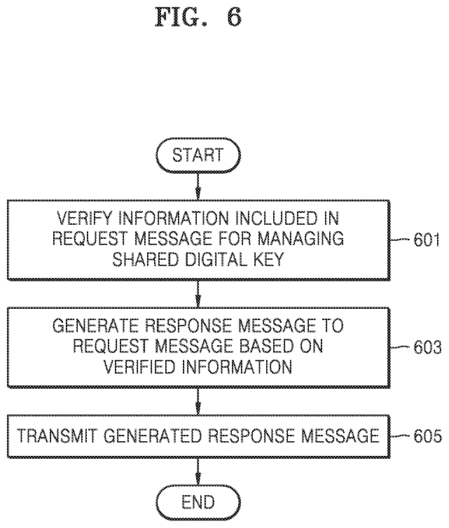

FIG. 6 is a flowchart of the operating process of the target device, according to various embodiments of the present disclosure. Hereinafter, the electronic device 310 may refer to the owner device 100 or the electronic device 240 of another user. In addition, the first backend server may refer to the backend server of the electronic device 310, and the second backend server may refer to the backend server of the target device 320. The backend server of the electronic device 310 may refer to the backend server 210 of the owner device or the backend server 230 for the electronic device of another user.

Although not illustrated in FIG. 6, in an embodiment, when the management of the shared digital key is initiated or triggered by the electronic device 310, the target device 320 may receive the above-described request message from the electronic device 310. In another embodiment, when the management of the shared digital key is initiated or triggered by the target device 320, operation 601 may be replaced with an operation of managing the shared digital key. In another embodiment, when the management of the shared digital key is initiated or triggered by the first backend server, the target device 320 may receive, from the second backend server, a request message changed from the request message transmitted from the first backend server. In another embodiment, when the management of the shared digital key is initiated or triggered by the second backend server, the target device 320 may receive the request message generated by the second backend server.

Referring to FIG. 6, in operation 601, the target device 320 may verify information included in the request message for managing the shared digital key. For example, the request message may include at least one of digital key information, request information, routing information, or a sender signature. In various embodiments, the request information may refer to information requesting the management of the shared digital key. For example, the management of the shared digital key may refer to revocation or updating of the shared digital key. Also, the target device 320 may verify, through the sender signature, whether the request message has been transmitted by a correct sender.

In operation 603, the target device 320 may generate a response message to the request message based on the verified information. For example, the target device 320 may generate a response message including information about the shared digital key, response information, routing information, or a signature of a sender transmitting the response message. In various embodiments, the response information may refer to a response to the management of the shared digital key. For example, the response to the management of the shared digital key may refer to a result of revoking or updating the shared digital key. In various embodiments, the signature of the sender who has transmitted the response message may refer to the signature of the user of the target device 320.

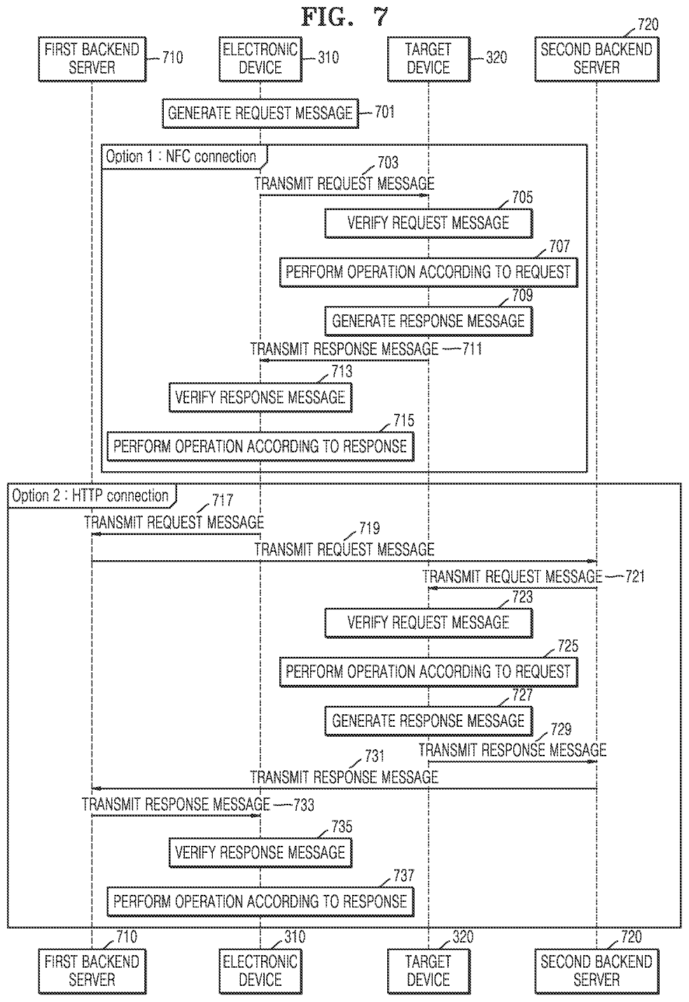

In operation 605, the target device 320 may transmit the generated response message. In an embodiment, when a communication method using NFC is used, the generated response message may be directly transmitted to the electronic device 310. In another embodiment, when a communication method using a hypertext transfer protocol (HTTP) is used, the generated response message may be transmitted to the first backend server or the electronic device 310 through the second backend server. Hereinafter, FIGS. 7 to 10 illustrate embodiments of digital key management operations according to a device that initiates or triggers management of a shared digital key.

FIG. 7 is a sequence diagram for schematically describing a digital key management method initiated or triggered by an electronic device, according to various embodiments of the present disclosure.

Referring to FIG. 7, an electronic device 310 may refer to the owner device 100 or the electronic device 240 of another user. A target device 320 may refer to the electronic device 11. For example, the electronic device 11 may refer to an automobile or an electronic device mounted on the automobile. In addition, a first backend server 710 may refer to a backend server of the electronic device 310, and a second backend server 720 may refer to a backend server of the target device 320. The backend server of the electronic device 310 may refer to the backend server 210 of the owner device or the backend server 230 for the electronic device of another user.

In operation 701, the electronic device 310 may generate a request message. That is, the electronic device 310 may generate a request message for managing a shared digital key of another user (e.g. , a friend). In various embodiments, the request message may include information about the shared digital key, request information, routing information, or a signature of a sender transmitting the request message. In an embodiment, the generated request message may be transmitted through an NFC connection between the electronic device 310 and the target device 320. Hereinafter, a communication scenario through an NFC connection may be referred to as an “option 1” scenario. In another embodiment, the generated request message may be transmitted through an HTTP communication method via the first backend server 710 or the second backend server 720. In this case, the HTTP communication method may refer to a communication method through an Internet connection. Hereinafter, a communication scenario through an HTTP connection may be referred to as an “option 2” scenario. In various embodiments, in the case of the option 1 scenario, operations 703 to 715 may be performed after operation 701.

In operation 703, the electronic device 310 may transmit the request message. For example, the electronic device 310 may transmit the generated request message to the target device 320. At this time, the request message may be transmitted through an NFC connection between the electronic device 310 and the target device 320.

In operation 705, the target device 320 may verify the received request message. For example, the target device 320 may verify information about the shared digital key, request information, or a signature of a sender transmitting the request message, which is included in the received request message.

In operation 707, the target device 320 may perform an operation according to the request. That is, the target device 320 may perform shared digital key management based on the information included in the request message. For example, when the request information of the request message includes information related to the revocation of the shared digital key, the target device 320 may revoke the shared digital key stored in the target device 320. When the request information of the request message includes information related to the updating of the shared digital key, the target device 320 may update the shared digital key stored in the target device 320.

In operation 709, the target device 320 may generate a response message. In various embodiments, the response message may include information about the shared digital key, response information, routing information, or a signature of a sender transmitting the response message. For example, the signature of the sender may refer to a signature of a user of the target device 320. In various embodiments, the response information may include information about a result of revoking or updating the shared digital key.

In operation 711, the target device 320 may transmit the response message. For example, the target device 320 may transmit the generated response message to the electronic device 310. At this time, the response message may be transmitted through an NFC connection between the electronic device 310 and the target device 320.

In operation 713, the electronic device 310 may verify the response message. For example, the electronic device 310 may verify information about the shared digital key, response information, or a signature of a sender transmitting the response message, which is included in the response message.

In operation 715, the electronic device 310 may perform an operation according to the response. That is, the electronic device 310 may perform shared digital key management based on the information included in the verified response message. For example, when the response information of the response message includes information related to the revocation of the shared digital key, the electronic device 310 may revoke the shared digital key stored in the electronic device 310. When the response information of the response message includes information related to the updating of the shared digital key, the electronic device 310 may update the shared digital key stored in the electronic device 310. In various embodiments, the information related to the management of the shared digital key of the electronic device 310 may be transmitted to the first backend server 710 or the second backend server 720. For example, the electronic device 310 may revoke or update the shared digital key and transmit, to the second backend server 720, information related to a result of the revoking or the updating. After that, the first backend server 710 may transmit, to the second backend server 720, information related to a result of the revoking or the updating. In various embodiments, in the case of the option 2 scenario, operations 717 to 737 may be performed after operation 701. In this case, operations 723 to 727 may be performed in the same manner as operations 705 to 709. In addition, operations 735 and 737 may be performed in the same manner as operations 713 and 715.

In operation 717, the electronic device 310 may transmit a request message. That is, the electronic device 310 may transmit the generated request message to the first backend server 710. In this case, a mutual authentication procedure between the electronic device 310 and the first backend server 710 may be performed.

In operation 719, the first backend server 710 may transmit the request message to the second backend server 720. For example, the first backend server 710 may identify the second backend server 720 by using routing information included in the request message, and may transmit the request message to the second backend server 720. In this case, a mutual authentication procedure between the first backend server 710 and the second backend server 720 may be performed.

In operation 721, the second backend server 720 may transmit a request message to the target device 320. In this case, a mutual authentication procedure between the second backend server 720 and the target device 320 may be performed.

In operation 723, the target device 320 may verify the request message. For example, the target device 320 may verify information about the shared digital key, request information, or a signature of a sender transmitting the request message, which is included in the received request message.

In operation 725, the target device 320 may perform an operation according to the request. That is, the target device 320 may perform shared digital key management based on the information included in the request message. For example, when the request information of the request message includes information related to the revocation of the shared digital key, the target device 320 may revoke the shared digital key stored in the target device 320. When the request information of the request message includes information related to the updating of the shared digital key, the target device 320 may update the shared digital key stored in the target device 320.

In operation 727, the target device 320 may generate a response message. In various embodiments, the response message may include information about the shared digital key, response information, routing information, or a signature of a sender transmitting the response message. For example, the signature of the sender may refer to a signature of a user of the target device 320. In various embodiments, the response information may include information about a result of revoking or updating the shared digital key.

In operation 729, the target device 320 may transmit a response message to the second backend server 720. In this case, a mutual authentication procedure between the target device 320 and the second backend server 720 may be performed.

In operation 731, the second backend server 720 may transmit the response message. For example, the second backend server 720 may identify the first backend server 710 by using routing information included in the response message, and may transmit the response message to the first backend server 710. In this case, a mutual authentication procedure between the first backend server 710 and the second backend server 720 may be performed.

In operation 733, the first backend server 710 may transmit the response message. That is, the first backend server 710 may transmit the received response message to the electronic device 310. In this case, a mutual authentication procedure between the electronic device 310 and the first backend server 710 may be performed.

In operation 735, the electronic device 310 may verify the response message. For example, the electronic device 310 may verify information about the shared digital key, response information, or a signature of a sender transmitting the response message, which is included in the response message.

In operation 737, the electronic device 310 may perform an operation according to the response. That is, the electronic device 310 may perform shared digital key management based on the information included in the verified response message. For example, when the response information of the response message includes information related to the revocation of the shared digital key, the electronic device 310 may revoke the shared digital key stored in the electronic device 310. When the response information of the response message includes information related to the updating of the shared digital key, the electronic device 310 may update the shared digital key stored in the electronic device 310.

When the digital key management procedure as described with reference to FIG. 7 is performed in the option 1 scenario and the option 2 scenario, the following operations may be performed.

In an embodiment, when the management (e.g. , revocation or updating) of the shared digital key of another user is initiated or triggered by the owner device 100, a notification about the management of the shared digital key may be transmitted to the electronic device 240 of another user or the backend server 230 for the electronic device of another user.

In another embodiment, when the management (e.g. , revocation) of the shared digital key of another user is initiated or triggered by the electronic device 240 of another user, a notification about the management of the shared digital key may be transmitted to the owner device 100 or the backend server 210 of the owner device. Through the procedures as described above, the digital key management operation initiated or triggered by the electronic device 310 may be performed.

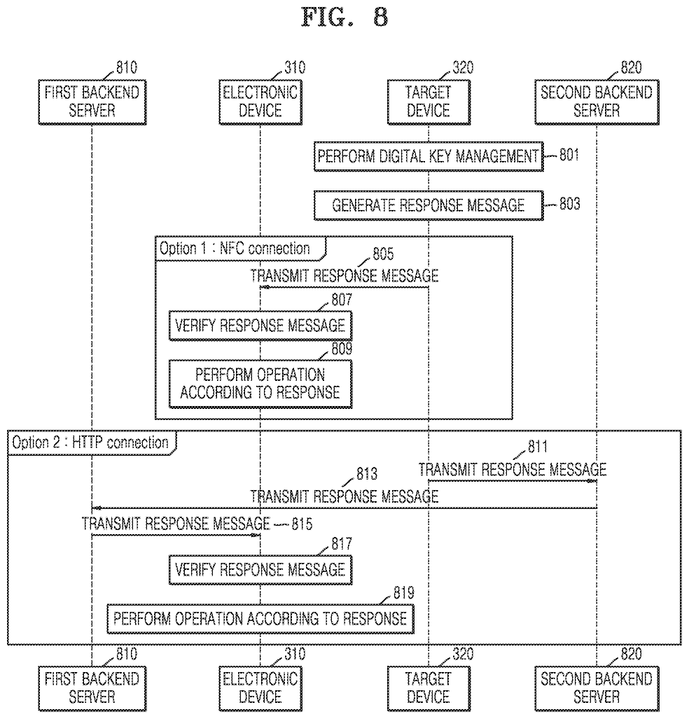

FIG. 8 is a sequence diagram for schematically describing a digital key management method initiated or triggered by a target device, according to various embodiments of the present disclosure.

Referring to FIG. 8, an electronic device 310 may refer to the owner device 100 or the electronic device 240 of another user. A target device 320 may refer to the electronic device 11. For example, the electronic device 11 may refer to an automobile or an electronic device mounted on the automobile. In addition, a first backend server 810 may refer to a backend server of the electronic device 310, and a second backend server 820 may refer to a backend server of the target device 320. The backend server of the electronic device 310 may refer to the backend server 210 of the owner device or the backend server 230 for the electronic device of another user.

In operation 801, the target device 320 may perform digital key management. Although not illustrated in FIG. 8, before the target device 320 performs digital key management, a digital key management operation may be initiated or triggered by a request of a requester requesting digital key management. For example, the requester may refer to the user 1 of the owner device 100 or another user (e.g. , a friend) other than the owner. In an embodiment, the requester may request shared digital key management through a physical button of the target device 320, a button on a user interface, or input of a password. When the target device 320 is started up, an additional authentication procedure for a shared digital key management request may not be required. In various embodiments, the requester's request for the shared digital key management to the target device 320 may be implemented in the form of a request message for managing the shared digital key. As described above, after the shared digital key management is requested, the target device 320 may perform a digital key management operation. For example, when the requester's request is to revoke the shared digital key, the target device 320 may revoke the shared digital key stored in the target device 320. When the requester's request is to update the shared digital key, the target device 320 may update the shared digital key stored in the target device 320.

In operation 803, the target device 320 may generate a response message. For example, the target device 320 may perform a shared digital key management operation and generate a result thereof in the form of a response message. In various embodiments, the response message may include information about the shared digital key, response information, routing information, or a signature of a sender transmitting the response message. For example, the signature of the sender may refer to a signature of a user of the target device 320. In various embodiments, the response information may include information about a result of revoking or updating the shared digital key. In an embodiment, the generated response message may be transmitted through an NFC connection between the electronic device 310 and the target device 320. Hereinafter, a communication scenario through an NFC connection may be referred to as an “option 1” scenario. In another embodiment, the generated response message may be transmitted through an HTTP communication method via the first backend server 810 or the second backend server 820. In this case, the HTTP communication method may refer to a communication method through an Internet connection. Hereinafter, a communication scenario through an HTTP connection may be referred to as an “option 2” scenario. In an embodiment, when the requester is the owner, the response message may be transmitted through an NFC connection between the electronic device 310 and the target device 320, or may be transmitted through an HTTP connection via the first backend server 810 or the second backend server 820. In another embodiment, when the requester is another user other than the owner, the response message may be transmitted through an HTTP connection via the first backend server 810 or the second backend server 820. In various embodiments, in the case of the option 1 scenario, operations 805 to 809 may be performed after operation 803.

In operation 805, the target device 320 may transmit the response message. For example, the target device 320 may transmit the generated response message to the electronic device 310. At this time, the response message may be transmitted through an NFC connection between the electronic device 310 and the target device 320.

In operation 807, the electronic device 310 may verify the response message. For example, the electronic device 310 may verify information about the shared digital key, response information, or a signature of a sender transmitting the response message, which is included in the response message.

In operation 809, the electronic device 310 may perform an operation according to the response. That is, the electronic device 310 may perform shared digital key management based on the information included in the verified response message. For example, when the response information of the response message includes information related to the revocation of the shared digital key, the electronic device 310 may revoke the shared digital key stored in the electronic device 310. When the response information of the response message includes information related to the updating of the shared digital key, the electronic device 310 may update the shared digital key stored in the electronic device 310. In various embodiments, the information related to the management of the shared digital key of the electronic device 310 may be transmitted to the first backend server 810 or the second backend server 820. For example, the electronic device 310 may revoke or update the shared digital key and transmit, to the first backend server 810, information related to a result of the revoking or the updating. After that, the first backend server 810 may transmit, to the second backend server 820, information related to a result of the revoking or updating. In various embodiments, in the case of the option 2 scenario, operations 811 to 819 may be performed after operation 803. At this time, operations 817 and 819 may be performed in the same manner as operations 807 and 809.

In operation 811, the target device 320 may transmit the response message. For example, the target device 320 may transmit the generated response message to the second backend server 820. In this case, a mutual authentication procedure between the target device 320 and the second backend server 820 may be performed.

In operation 813, the second backend server 820 may transmit the response message. For example, the second backend server 820 may identify the first backend server 810 by using routing information included in the response message, and may transmit the response message to the first backend server 810. In this case, a mutual authentication procedure between the first backend server 810 and the second backend server 820 may be performed.

In operation 815, the first backend server 810 may transmit the response message. That is, the first backend server 810 may transmit the received response message to the electronic device 310. In this case, a mutual authentication procedure between the electronic device 310 and the first backend server 810 may be performed.

In operation 817, the electronic device 310 may verify the response message. For example, the electronic device 310 may verify information about the shared digital key, response information, or a signature of a sender transmitting the response message, which is included in the response message.

In operation 819, the electronic device 310 may perform an operation according to the response. That is, the electronic device 310 may perform shared digital key management based on the information included in the verified response message. For example, when the response information of the response message includes information related to the revocation of the shared digital key, the electronic device 310 may revoke the shared digital key stored in the electronic device 310. When the response information of the response message includes information related to the updating of the shared digital key, the electronic device 310 may update the shared digital key stored in the electronic device 310.

When the digital key management procedure as described with reference to FIG. 8 is performed in the option 1 scenario and the option 2 scenario, the following operations may be performed.

In an embodiment, when the management (e.g. , revocation or updating) of the shared digital key of another user is requested by the owner, a notification about the management of the shared digital key may be transmitted to the electronic device 240 of another user or the backend server 230 for the electronic device of another user.

In another embodiment, when the management (e.g. , revocation) of the shared digital key of another user is requested by another user, a notification about the management of the shared digital key may be transmitted to the owner device 100 or the backend server 210 of the owner device. Through the procedures as described above, the digital key management operation initiated or triggered by the target device 320 may be performed.

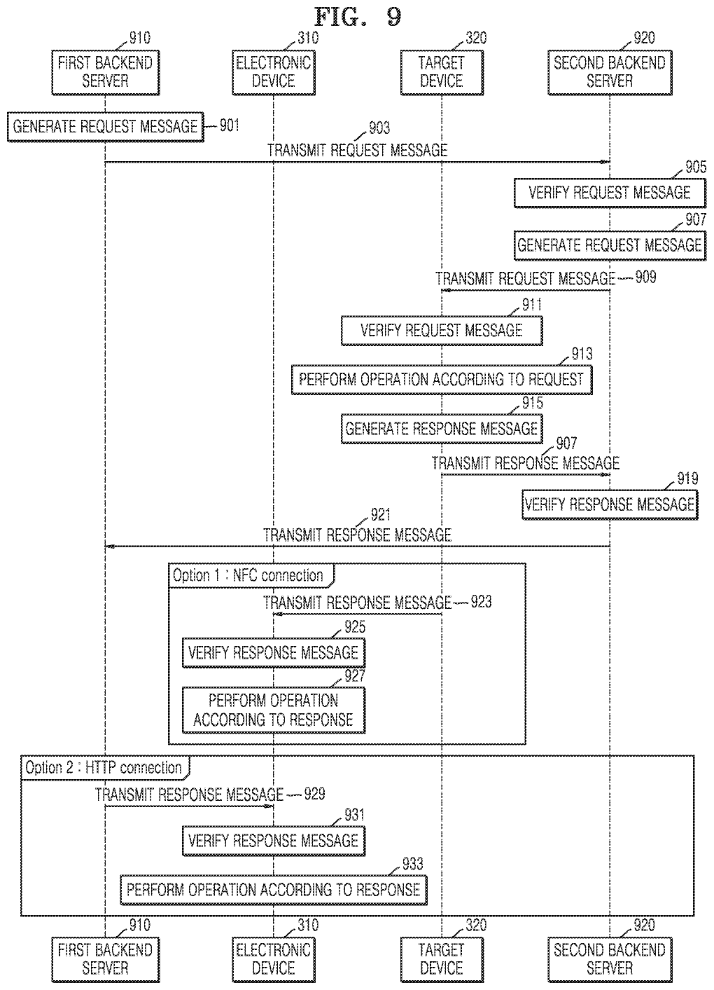

FIG. 9 is a sequence diagram for schematically describing a digital key management method initiated or triggered by a first backend server, according to various embodiments of the present disclosure.

Referring to FIG. 9, an electronic device 310 may refer to the owner device 100 or the electronic device 240 of another user. A target device 320 may refer to the electronic device 11. For example, the electronic device 11 may refer to an automobile or an electronic device mounted on the automobile. In addition, a first backend server 910 may refer to a backend server of the electronic device 310, and a second backend server 920 may refer to a backend server of the target device 320. The backend server of the electronic device 310 may refer to the backend server 210 of the owner device or the backend server 230 for the electronic device of another user.

In operation 901, the first backend server 910 may generate the request message. In various embodiments, the requester may request the shared digital key management to the first backend server 910. In an embodiment, the request may refer to a request through a call of the requester or an application on the electronic device of the requester. The above-described request message may include information about the shared digital key, request information, routing information, or a signature of a sender transmitting the request message. Because the first backend server 910 transmits the request message, the request message may include the signature of the first backend server 910.

In operation 903, the first backend server 910 may transmit the request message. In various embodiments, the first backend server 910 may identify the second backend server 920 by using routing information included in the request message. The first backend server 910 may transmit the request message to the identified second backend server 920. In this case, a mutual authentication procedure between the first backend server 910 and the second backend server 920 may be performed.

In operation 905, the second backend server 920 may verify the request message. For example, the second backend server 920 may verify information about the shared digital key, request information, routing information, or a signature of a sender transmitting the request message, which is included in the request message.

In operation 907, the second backend server 920 may generate the request message. That is, the second backend server 920 may generate a new request message by using information included in the request message received from the first backend server 910. In an embodiment, when the shared digital key management operation is initiated or triggered by the first backend server 910, the second backend server 920 may replace the signature of the first backend server 910 included in the received request message with its own signature. In another embodiment, the second backend server 920 may add its own signature in addition to the signature of the first backend server 910 included in the received request message. In another embodiment, the second backend server 920 may transmit the received request message to the target device 320 without generating a new request message. That is, the second backend server 920 may reuse the request message received from the first backend server 910 without generating a new request message based on the request message received from the first backend server 910. As described above, when the second backend server 920 does not generate a new request message, operation 907 may be omitted.

In operation 909, the second backend server 920 may transmit the request message. That is, the second backend server 920 may transmit, to the target device 320, the request message including its own signature. In this case, a mutual authentication procedure between the target device 320 and the second backend server 920 may be performed. In another embodiment, when the second backend server 920 does not generate a new request message and transmits, to the target device 320, the request message received from the first backend server 910, the second backend server 920 may transmit, to the target device 320, a message including its own signature or the signature of the first backend server 910.

In operation 911, the target device 320 may verify the received request message. For example, the target device 320 may verify information about the shared digital key, request information, or a signature of a sender transmitting the request message, which is included in the received request message. For example, the target device 320 may verify a request for the revocation or the updating of the shared digital key through the request information included in the request message. Also, the target device 320 may verify that the sender signature included in the request message is the signature of the second backend server 920. In another embodiment, when the second backend server 920 does not generate a new request message and transmits, to the target device 320, the request message received from the first backend server 910, the target device 320 may verify that the sender signature included in the request message is the signature of the first backend server 910 or the second backend server 920.

In operation 913, the target device 320 may perform an operation according to the request. That is, the target device 320 may perform shared digital key management based on the information included in the request message. For example, when the request information of the request message includes information related to the revocation of the shared digital key, the target device 320 may revoke the shared digital key stored in the target device 320. When the request information of the request message includes information related to the updating of the shared digital key, the target device 320 may update the shared digital key stored in the target device 320.

In operation 915, the target device 320 may generate a response message. In various embodiments, the response message may include information about the shared digital key, response information, routing information, or a signature of a sender transmitting the response message. For example, the signature of the sender may refer to a signature of a user of the target device 320. In various embodiments, the response information may include information about a result of revoking or updating the shared digital key.

In operation 917, the target device 320 may transmit the response message. For example, the target device 320 may transmit the generated response message to the second backend server 920. In this case, a mutual authentication procedure between the target device 320 and the second backend server 920 may be performed.

In operation 919, the second backend server 920 may verify the response message. For example, the second backend server 920 may verify routing information included in the response message. The second backend server 920 may identify, as the first backend server 910, a target to which the response message is to be transmitted, based on the verified routing information.

In operation 921, the second backend server 920 may transmit the response message. For example, the second backend server 920 may transmit the verified response message to the first backend server 910. In this case, a mutual authentication procedure between the first backend server 910 and the second backend server 920 may be performed.

In various embodiments, a response message to the request message requesting the shared digital key management may be transmitted to the electronic device of the digital key management requester. In an embodiment, when the requester is the owner, the response message may be transmitted through an NFC connection between the electronic device 310 and the target device 320, or may be transmitted through an HTTP connection via the first backend server 910 or the second backend server 920. In another embodiment, when the requester is another user other than the owner, the response message may be transmitted through an HTTP connection via the first backend server 910 or the second backend server 920. In an embodiment, the response message generated by the target device 320 in operation 915 may be transmitted through an NFC connection between the electronic device 310 and the target device 320. Hereinafter, a communication scenario through an NFC connection may be referred to as an “option 1” scenario. In another embodiment, the response message generated by the target device 320 may be transmitted through the HTTP communication method via the first backend server 910 or the second backend server 920. In this case, the HTTP communication method may refer to a communication method through an Internet connection. Hereinafter, a communication scenario through an HTTP connection may be referred to as an “option 2” scenario. In various embodiments, in the case of the option 1 scenario, operations 923 to 927 may be performed after operation 921.

In operation 923, the target device 320 may transmit the response message. For example, the target device 320 may transmit the generated response message to the electronic device 310. At this time, the response message may be transmitted through an NFC connection between the electronic device 310 and the target device 320.

In operation 925, the electronic device 310 may verify the response message. For example, the electronic device 310 may verify information about the shared digital key, response information, or a signature of a sender transmitting the response message, which is included in the response message.

In operation 927, the electronic device 310 may perform an operation according to the response. That is, the electronic device 310 may perform shared digital key management based on the information included in the verified response message. For example, when the response information of the response message includes information related to the revocation of the shared digital key, the electronic device 310 may revoke the shared digital key stored in the electronic device 310. When the response information of the response message includes information related to the updating of the shared digital key, the electronic device 310 may update the shared digital key stored in the electronic device 310. In various embodiments, in the case of the option 2 scenario, operations 929 to 933 may be performed after operation 921. At this time, operations 931 and 933 may be performed in the same manner as operations 925 and 927.

In operation 929, the first backend server 910 may transmit the response message. For example, the first backend server 910 may transmit, to the electronic device 310, the response message received from the second backend server 920 in operation 921. In this case, a mutual authentication procedure between the first backend server 910 and the electronic device 310 may be performed.

In operation 931, the electronic device 310 may verify the response message. For example, the electronic device 310 may verify information about the shared digital key, response information, or a signature of a sender transmitting the response message, which is included in the response message.

In operation 933, the electronic device 310 may perform an operation according to the response. That is, the electronic device 310 may perform shared digital key management based on the information included in the verified response message. For example, when the response information of the response message includes information related to the revocation of the shared digital key, the electronic device 310 may revoke the shared digital key stored in the electronic device 310. When the response information of the response message includes information related to the updating of the shared digital key, the electronic device 310 may update the shared digital key stored in the electronic device 310.

When the digital key management procedure as described with reference to FIG. 9 is performed in the option 1 scenario and the option 2 scenario, the following operations may be performed.

In an embodiment, when the management (e.g. , revocation or updating) of the shared digital key of another user is requested by the owner, a notification about the management of the shared digital key may be transmitted to the electronic device 240 of another user or the backend server 230 for the electronic device of another user.

In another embodiment, when the management (e.g. , revocation) of the shared digital key of another user is requested by another user, a notification about the management of the shared digital key may be transmitted to the owner device 100 or the backend server 210 of the owner device. Through the procedures as described above, the digital key management operation initiated or triggered by the first backend server may be performed.

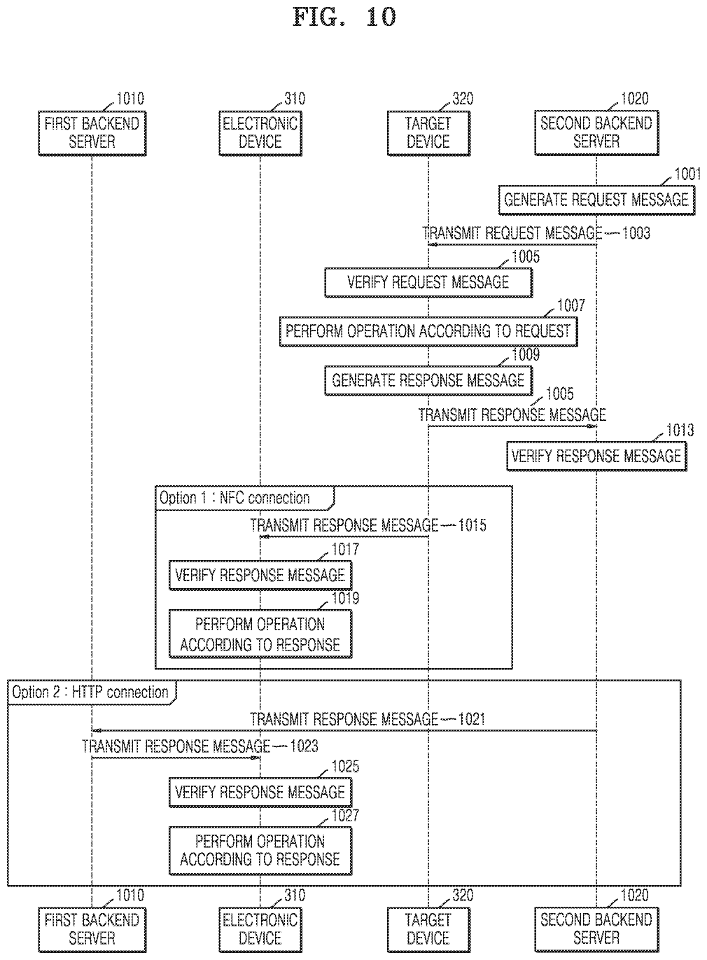

FIG. 10 is a sequence diagram for schematically describing a digital key management method initiated or triggered by a second backend server, according to various embodiments of the present disclosure.

Referring to FIG. 10, an electronic device 310 may refer to the owner device 100 or the electronic device 240 of another user. A target device 320 may refer to the electronic device 11. For example, the electronic device 11 may refer to an automobile or an electronic device mounted on the automobile. In addition, a first backend server 1010 may refer to a backend server of the electronic device 310, and a second backend server 1020 may refer to a backend server of the target device 320. The backend server of the electronic device 310 may refer to the backend server 210 of the owner device or the backend server 230 for the electronic device of another user.

In operation 1001, the second backend server 1020 may generate a request message. In various embodiments, a requester may request a shared digital key management to the second backend server 1020. In an embodiment, the request may refer to a request through a call of the requester or an application on the electronic device of the requester. The above-described request message may include information about the shared digital key, request information, routing information, or a signature of a sender transmitting the request message. Because the second backend server 1020 transmits the request message, the request message may include the signature of the second backend server 1020.

In operation 1003, the second backend server 1020 may transmit the request message. That is, the second backend server 1020 may transmit, to the target device 320, the request message including its own signature. In this case, a mutual authentication procedure between the target device 320 and the second backend server 1020 may be performed.

In operation 1005, the target device 320 may verify the received request message. For example, the target device 320 may verify information about the shared digital key, request information, or a signature of a sender transmitting the request message, which is included in the received request message. For example, the target device 320 may verify a request for the revocation or the updating of the shared digital key through the request information included in the request message. Also, the target device 320 may verify that the sender signature included in the request message is the signature of the second backend server 920.

In operation 1007, the target device 320 may perform an operation according to the request. That is, the target device 320 may perform shared digital key management based on the information included in the request message. For example, when the request information of the request message includes information related to the revocation of the shared digital key, the target device 320 may revoke the shared digital key stored in the target device 320. When the request information of the request message includes information related to the updating of the shared digital key, the target device 320 may update the shared digital key stored in the target device 320.

In operation 1009, the target device 320 may generate a response message. In various embodiments, the response message may include information about the shared digital key, response information, routing information, or a signature of a sender transmitting the response message. For example, the signature of the sender may refer to a signature of a user of the target device 320. In various embodiments, the response information may include information about a result of revoking or updating the shared digital key.

In operation 1011, the target device 320 may transmit a response message. For example, the target device 320 may transmit the generated response message to the second backend server 1020. In this case, a mutual authentication procedure between the target device 320 and the second backend server 1020 may be performed.

In operation 1013, the second backend server 1020 may verify the response message. For example, the second backend server 1020 may verify routing information included in the response message. In an embodiment, the second backend server 1020 may identify, as the first backend server 1010, a target to which the response message is to be transmitted, based on the verified routing information.

In various embodiments, a response message to the request message requesting the shared digital key management may be transmitted to the electronic device of the digital key management requester. In an embodiment, when the requester is the owner, the response message may be transmitted through an NFC connection between the electronic device 310 and the target device 320, or may be transmitted through an HTTP connection via the first backend server 910 or the second backend server 920. In another embodiment, when the requester is another user other than the owner, the response message may be transmitted through an HTTP connection via the first backend server 910 or the second backend server 920. In an embodiment, the response message generated by the target device 320 in operation 1009 may be transmitted through an NFC connection between the electronic device 310 and the target device 320. Hereinafter, a communication scenario through an NFC connection may be referred to as an “option 1” scenario. In another embodiment, the response message generated by the target device 320 may be transmitted through the HTTP communication method via the first backend server 910 or the second backend server 920. In this case, the HTTP communication method may refer to a communication method through an Internet connection. Hereinafter, a communication scenario through an HTTP connection may be referred to as an “option 2” scenario. In various embodiments, in the case of the option 1 scenario, operations 1015 to 1019 may be performed after operation 1013.

In operation 1015, the target device 320 may transmit a response message. For example, the target device 320 may transmit the generated response message to the electronic device 310. At this time, the response message may be transmitted through an NFC connection between the electronic device 310 and the target device 320.

In operation 1017, the electronic device 310 may verify the response message. For example, the electronic device 310 may verify information about the shared digital key, response information, or a signature of a sender transmitting the response message, which is included in the response message.

In operation 1019, the electronic device 310 may perform an operation according to the response. That is, the electronic device 310 may perform shared digital key management based on the information included in the verified response message. For example, when the response information of the response message includes information related to the revocation of the shared digital key, the electronic device 310 may revoke the shared digital key stored in the electronic device 310. When the response information of the response message includes information related to the updating of the shared digital key, the electronic device 310 may update the shared digital key stored in the electronic device 310. In various embodiments, the information related to the management of the shared digital key of the electronic device 310 may be transmitted to the first backend server 1010. For example, the electronic device 310 may revoke or update the shared digital key and transmit, to the first backend server 1010, information related to a result of the revoking and updating.

In various embodiments, in the case of the option 2 scenario, operations 1021 to 1027 may be performed after operation 1013. At this time, operations 1025 and 1027 may be performed in the same manner as operations 1017 and 1019.

In operation 1021, the second backend server 1020 may transmit a response message. For example, the second backend server 1020 may transmit the verified response message to the first backend server 1010. In this case, a mutual authentication procedure between the first backend server 1010 and the second backend server 1020 may be performed.

In operation 1023, the first backend server 1010 may transmit the response message. For example, the first backend server 1010 may transmit, to the electronic device 310, the response message received from the second backend server 1020 in operation 1021. In this case, a mutual authentication procedure between the first backend server 1010 and the electronic device 310 may be performed.

In operation 1025, the electronic device 310 may verify the response message. For example, the electronic device 310 may verify information about the shared digital key, response information, or a signature of a sender transmitting the response message, which is included in the response message.

In operation 1027, the electronic device 310 may perform an operation according to the response. That is, the electronic device 310 may perform shared digital key management based on the information included in the verified response message. For example, when the response information of the response message includes information related to the revocation of the shared digital key, the electronic device 310 may revoke the shared digital key stored in the electronic device 310. When the response information of the response message includes information related to the updating of the shared digital key, the electronic device 310 may update the shared digital key stored in the electronic device 310.

When the digital key management procedure as described with reference to FIG. 10 is performed in the option 1 scenario and the option 2 scenario, the following operations may be performed.

In an embodiment, when the management (e.g. , revocation or updating) of the shared digital key of another user is requested by the owner, a notification about the management of the shared digital key may be transmitted to the electronic device 240 of another user or the backend server 230 for the electronic device of another user.

In another embodiment, when the management (e.g. , revocation) of the shared digital key of another user is requested by another user, a notification about the management of the shared digital key may be transmitted to the owner device 100 or the backend server 210 of the owner device. Through the procedures as described above, the digital key management operation initiated or triggered by the second backend server may be performed.

An operating method of the electronic device 310 for managing a digital key, according to various embodiments of the present disclosure, may include: receiving a response message to a request message for managing a shared digital key; verifying information included in the received response message; and managing the shared digital key based on the verified information.

According to various embodiments of the present disclosure, the request message may include at least one of information about the shared digital key, request information, routing information, or a signature of a device transmitting the request message, and the response message may include at least one of information about the shared digital key, response information, routing information, or a signature of a device transmitting the response message.

According to various embodiments of the present disclosure, the request information may include information requesting the shared digital key management, the response information may include a result of management the shared digital key, and the shared digital key management may include at least one of revoking or updating the shared digital key.

According to various embodiments of the present disclosure, the revoking of the shared digital key may refer to revocation of the permission to share the shared digital key, and the updating of the shared digital key may refer to updating information about an expiration date of the shared digital key or the permission to use the shared digital key.

The operating method of the electronic device 310, according to various embodiments of the present disclosure, may further include transmitting the information about the shared digital key management to the third electronic device 310.

The request message or the response message according to various embodiments of the present disclosure may be transmitted through a communication method using NFC or a communication method using HTTP. In an embodiment, when a communication method using HTTP is used, the request message or the response message may be transmitted through the first backend server or the second backend server.

The operating method of the electronic device 310, according to various embodiments of the present disclosure, may include: generating a request message for managing a shared digital key; and transmitting the generated request message to the target device 320.

According to various embodiments of the present disclosure, when shared digital key management is initiated or triggered by the first backend server, the request message may be generated by the first backend server, the generated request message may be transmitted to the second backend server, and the response message may be a response message to the request message changed based on the request message transmitted to the second backend server.

According to various embodiments of the present disclosure, when shared digital key management is initiated or triggered by the second backend server, the request message may be generated by the second backend server, the generated request message may be transmitted to the target device 320, and the response message may be a response message to the request message transmitted to the target device 320.

An operating method of the target device 320 for managing a digital key, according to various embodiments of the present disclosure, may include: verifying information included in the request message for managing the shared digital key; generating a response message to the request message based on the verified information; and transmitting the generated response message.

The operating method of the target device 320, according to various embodiments of the present disclosure, may further include receiving the request message for managing the shared digital key. The request message may include at least one of information about the shared digital key, request information, routing information, or a signature of a device transmitting the request message. The response message may include at least one of information about the shared digital key, response information, routing information, or a signature of a device transmitting the response message.

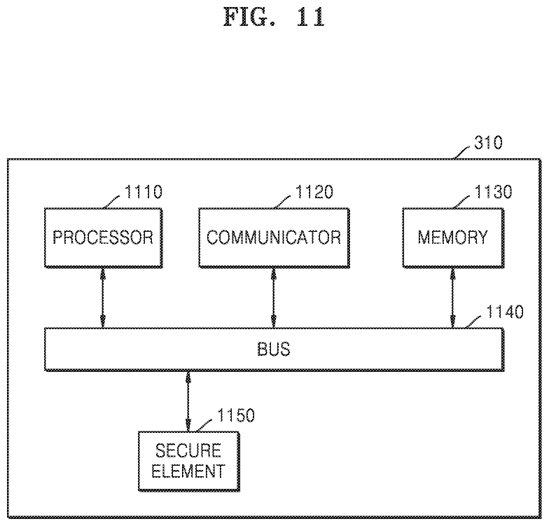

FIGS. 11 to 13 illustrates configurations of an electronic device and a target device.

FIG. 11 is a diagram illustrating a configuration of an electronic device 310, according to various embodiments of the present disclosure. In FIG. 11, the electronic device 310 may refer to the owner device 100 or the electronic device 240 of another user.

Referring to FIG. 11, the electronic device 310 may include a processor 1110, a communicator 1120, a memory 1130, a secure element 1150, and a bus 1140 connecting the elements to each other. However, the electronic device 310 may be implemented by more elements than the elements illustrated in FIG. 11.

Although FIG. 11 illustrates that the electronic device 310 includes one processor, embodiments of the present disclosure are not limited thereto, and the electronic device 310 may include a plurality of processors. At least some operations and functions of the processor 1110 may be performed by a plurality of processors. The electronic device 310 illustrated in FIG. 11 may perform the method for managing the shared digital key, according to various embodiments of the present disclosure, and the descriptions of FIGS. 3 to 10 may be applied thereto. Therefore, contents overlapping the above description will be omitted.

The communicator 1120 may perform wired and/or wireless communication with other devices, servers, or networks. To this end, the communicator 1120 may include a communication module supporting at least one of various wired and/or wireless communication methods. For example, the communication module may be in the form of a chipset, or may be a sticker/barcode (e.g. , a sticker including an NFC tag) including information necessary for communication.

The wireless communication may include, for example, at least one of cellular communication, wireless fidelity (Wi-Fi), Wi-Fi Direct, Bluetooth, ultra wide band (UWB), or NFC. The wired communication may include, for example, at least one of universal serial bus (USB) or high definition multimedia interface (HDMI).

In an embodiment, the communicator 1120 may include a communication module for short range communication. For example, the communicator 1120 may include a communication module that performs various short range communication such as infrared communication, magnetic secure transmission (MST), and magnetic secure communication, in addition to Wi-Fi, Wi-Fi Direct, Bluetooth, and NFC.

Various types of data such as files and programs such as applications may be installed and stored in the memory 1130. The processor 1110 may access and use data stored in the memory 1130, or may store new data in the memory 1130. In an embodiment, programs and data for managing the digital key may be installed and stored in the memory 1130. However, embodiments of the present disclosure are not limited thereto, and programs and data for managing the digital key may be installed and stored in the secure element 1150. In an embodiment, information about the shared digital key of another user other than the owner may be stored in the memory 1130.

The secure element 1150 is a secure storage of the electronic device 310 and is a secure area accessible only by an authenticated application. The secure element 1150 may be configured to be separated from a general storage area in a software manner, or may be configured to be physically separated from the memory 1130.

The processor 1110 may control the overall operations of the electronic device 310, and may include at least one processor such as a central processing unit (CPU) or a graphics processing unit (GPU). The processor 1110 may control other elements included in the electronic device 310 so as to perform the operation for managing the shared digital key.

The processor 1110 may execute programs stored in the memory 1130 and the secure element 1150, may read a stored file, or may store a new file.

The bus 1140 is a common data transmission path connecting the communicator 1120, the memory 1130, the secure element 1150, and the processor 1110.

In various embodiments of the present disclosure, the communicator 1120 may receive a response message to the request message for managing the shared digital key. The processor 1110 may verify information included in the received response message and manage the shared digital key based on the verified information.

In various embodiments of the present disclosure, the request message may include at least one of information about the shared digital key, request information, routing information, or a signature of a device transmitting the request message. Also, the response message may include at least one of information about the shared digital key, response information, routing information, or a signature of a device transmitting the response message.

In various embodiments of the present disclosure, the request information may include information requesting shared digital key management. The response information may include a result of managing the shared digital key. Also, the shared digital key management may include at least one of revocation or updating of the shared digital key.

In various embodiments of the present disclosure, the revocation of the shared digital key may include revocation of the permission to share the shared digital key. The updating of the shared digital key may refer to updating information about the expiration date of the shared digital key or the permission to use the shared digital key.

In various embodiments of the present disclosure, the processor 1110 may transmit information about the shared digital key management to the third electronic device. At this time, the third electronic device may refer to the owner device 100, the electronic device 240 of another user, the owner device backend server 210, the target device backend server 220, or the backend server 230 for the electronic device of another user.

In various embodiments of the present disclosure, the request message or the response message may be transmitted through a communication method using NFC or a communication method using HTTP. In an embodiment, when the communication method using HTTP is used, the request message or the response message may be transmitted through the first backend server or the second backend server.

In various embodiments of the present disclosure, the processor 1110 may generate a request message for managing the shared digital key, and the communicator 1120 may transmit the generated request message to the target device.

In various embodiments of the present disclosure, when the digital key management is initiated or triggered by the first backend server, the request message may be generated by the first backend server, and the generated request message may be transmitted to the second backend server. The response message may be a response message to the request message changed based on the request message transmitted to the second backend server.

According to various embodiments of the present disclosure, when the shared digital key management is initiated or triggered by the second backend server, the request message may be generated by the second backend server, the generated request message may be transmitted to the target device, and the response message may be a response message to the request message transmitted to the target device.

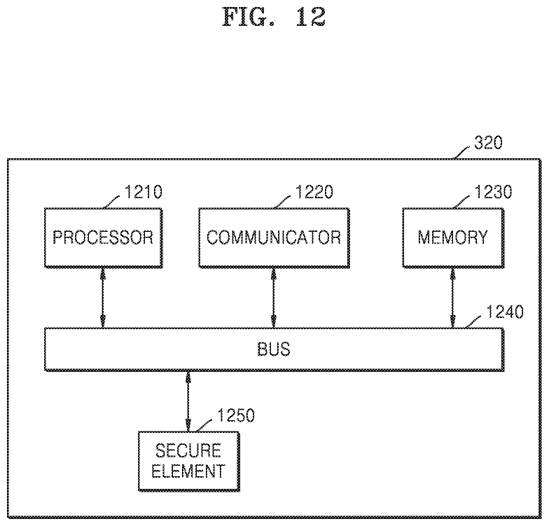

FIG. 12 is a diagram illustrating a configuration of a target device 320, according to various embodiments of the present disclosure. In FIG. 12, the target device 320 may refer to the electronic device 11.

Referring to FIG. 12, the target device 320 may include a processor 1210, a communicator 1220, a memory 1230, a secure element 1250, and a bus 1240 connecting the elements to each other. However, the target device 320 may be implemented by more elements than the elements illustrated in FIG. 12.

Although FIG. 12 illustrates that the target device 320 includes one processor, embodiments of the present disclosure are not limited thereto, and the target device 320 may include a plurality of processors. At least some operations and functions of the processor 1210 may be performed by a plurality of processors. The target device 320 illustrated in FIG. 12 may perform the method for managing the shared digital key, according to various embodiments of the present disclosure, and the descriptions of FIGS. 3 to 10 may be applied thereto. Therefore, contents overlapping the above description will be omitted.

The communicator 1220 may perform wired and/or wireless communication with other devices, servers, or networks. To this end, the communicator 1220 may include a communication module supporting at least one of various wired and/or wireless communication methods. For example, the communication module may be in the form of a chipset, or may be a sticker/barcode (e.g. , a sticker including an NFC tag) including information necessary for communication.

The wireless communication may include, for example, at least one of cellular communication, wireless fidelity (Wi-Fi), Wi-Fi Direct, Bluetooth, ultra wide band (UWB), or NFC. The wired communication may include, for example, at least one of USB or HDMI.

In an embodiment, the communicator 1220 may include a communication module for short range communication. For example, the communicator 1120 may include a communication module that performs various short range communication such as infrared communication, MST, and magnetic secure communication, in addition to Wi-Fi, Wi-Fi Direct, Bluetooth, and NFC.

Various types of data such as files and programs such as applications may be installed and stored in the memory 1230. The processor 1210 may access and use data stored in the memory 1230, or may store new data in the memory 1230. In an embodiment, programs and data for managing the digital key may be installed and stored in the memory 1230. However, embodiments of the present disclosure are not limited thereto, and programs and data for managing the digital key may be installed and stored in the secure element 1250. In an embodiment, information about the shared digital key of another user other than the owner may be stored in the memory 1230.

The secure element 1250 is a secure storage of the target device 320 and is a secure area accessible only by an authenticated application. The secure element 1250 may be configured to be separated from a general storage area in a software manner, or may be configured to be physically separated from the memory 1230.

The processor 1210 may control the overall operations of the target device 320, and may include at least one processor such as a CPU or a GPU. The processor 1210 may control other elements included in the target device 320 so as to perform the operation for managing the shared digital key.

The processor 1210 may execute programs stored in the memory 1230 and the secure element 1250, may read a stored file, or may store a new file.

The bus 1240 is a common data transmission path connecting the communicator 1220, the memory 1230, the secure element 1250, and the processor 1210.

In various embodiments of the present disclosure, the processor 1210 may verify information included in the request message for managing the shared digital key. The processor 1210 may generate a response message to the request message based on the verified information. The communicator 1220 may transmit the generated response message.

In various embodiments of the present disclosure, the communicator 1220 may receive the response message for managing the shared digital key. In this case, the request message may include at least one of information about the shared digital key, request information, routing information, or a signature of a device transmitting the request message, and the response message may include at least one of information about the shared digital key, response information, routing information, or a signature of a device transmitting the response message.

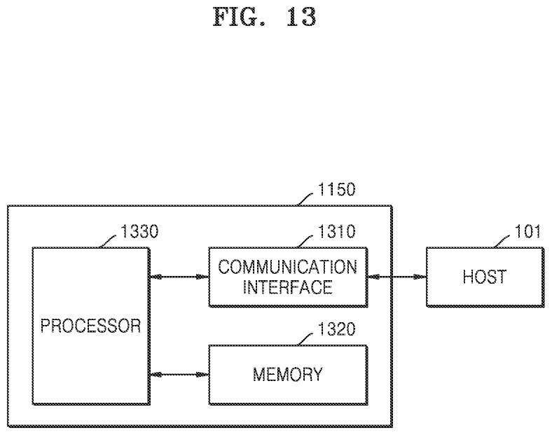

FIG. 13 is a diagram illustrating a configuration of a secure element 1150, according to various embodiments of the present disclosure.

Referring to FIG. 13, the secure element 1150 may include a communication interface 1310, a memory 1320, and a processor 1330.

In various embodiments, the secure element 1150 is a secure storage of the electronic device 310 and is a secure area accessible only by an authenticated application. In an embodiment, the secure element 1150 may include an embedded secure element (eSE), a universal integrated circuit card (UICC), a secure digital card (SD Card), an embedded UICC (eUICC), and/or a trusted execution environment (TEE), and the like.

The communication interface 1310 may communicate with a host 101. In an embodiment, the communication interface 1310 may include at least one of various wired and/or wireless communication interfaces for communicating with the host 101. The host 101 may be one of devices included in the electronic device 310, and may include, for example, an application processor (AP), a memory, and the like. The communication interface 1310 may be, for example, a serial interface such as ISO 7816, USB, inter-integrated circuit (IC), serial peripheral interface (SPI), single wire protocol (SWP), and/or ultra wide band (UWB), or any serial interface commonly used for communication between two hardware devices. Also, the communication interface 1310 may be a wireless interface such as ISO 14443, Zigbee, Bluetooth, or the like, which directly connects an antenna to a hardware device. Furthermore, the communication interface 1310 may be a parallel interface connected to a central bus of the electronic device 310. In this case, the communication interface 1310 may include a buffer that receives commands and data from the host 101.

Various types of data such as files and programs such as applications may be installed and stored in the memory 1320. The processor 1330 may access and use data stored in the memory 1320, or may store new data in the memory 1320. In an embodiment, programs and data for processing the digital key may be installed and stored in the memory 1320.

The processor 1330 may control the overall operations of the secure element 1150, and may include at least one processor such as a CPU or a GPU. The processor 1330 may control other elements included in the secure element 1150 to perform operations for processing the digital key. For example, the processor 1330 may execute programs stored in the memory 1320, may read a stored file, or may store a new file. In an embodiment, the processor 1330 may perform an operation of processing the digital key by executing a program stored in the memory 1320.

On the other hand, the secure element 1150 of FIG. 11 corresponds to the secure element 1250 of FIG. 12. The description of FIG. 11 may be equally applied to the secure element 1250 of FIG. 12.

The methods according to the embodiments of the present disclosure, which are described in the claims or the specification, may be implemented as hardware, software, or a combination of hardware and software.

When implemented as software, a computer-readable storage medium storing one or more programs (software modules) may be provided. One or more programs stored in the computer-readable storage medium are configured to be executable by one or more processors in an electronic device. One or more programs include instructions that cause the electronic device to execute the methods according to the embodiments of the present disclosure, which are described in the claims or the specification of the present disclosure.

One or more programs (software modules, software, etc.) may be stored in RAM, non-volatile memory including flash memory, ROM, electrically erasable programmable read only memory (EEPROM), magnetic disc storage device, CD-ROM, DVD, other types of optical storage devices, or magnetic cassette. Alternatively, one or more programs may be stored in a memory provided by a combination of all or part of these devices. Also, each memory may include a plurality of configured memories.

Also, one or more programs may be stored in an attachable storage device that is accessible through a communication network such as Internet, intranet, local area network (LAN), wide LAN (WLAN), or storage area network (SAN), or communication network provided by a combination thereof These storage devices may be connected through an external port to a device that performs the embodiments of the present disclosure. Also, a separate storage on the communication network may access the device that performs the embodiment of the present disclosure.

Although specific embodiments have been described in the detailed description of the present disclosure, various modifications may be made without departing from the scope of the present disclosure. Therefore, the scope of the present disclosure should not be limited to the above-described embodiments of the present disclosure and should be determined by the appended claims and the equivalents thereof.

Block diagrams disclosed in the present disclosure may be interpreted by those of ordinary skill in the art as conceptual representations of circuits for implementing the principles of the present disclosure. Similarly, it will be appreciated by those of ordinary skill in the art that any flow charts, flow diagrams, state transition diagrams, pseudo-codes, and the like may be represented substantially in a computer-readable medium, and a computer or a processor, whether or not explicitly illustrated, represents a variety of processes that may be executed by the computer or the processor. Therefore, the above-described embodiments of the present disclosure may be written as a program that is executable on a computer, and may be implemented in a general-purpose digital computer that operates the program by using a computer-readable recording medium. The computer-readable recording medium includes a storage medium such as a magnetic storage medium (e.g. , read-only memory (ROM), floppy disk, hard disk, etc.) and an optically readable medium (e.g. , compact disc read-only memory (CD-ROM), digital versatile disc (DVD), etc.).

Functions of various elements illustrated in the drawings may be provided through the use of dedicated hardware as well as hardware capable of executing software in association with appropriate software. When provided by a processor, such functions may be provided by a single dedicated processor, a single shared processor, or a plurality of individual processors, some of which may be shared. Furthermore, explicit use of the terms “processor” or “controller” should not be construed as referring exclusively to hardware capable of executing software, and the processor or the controller may implicitly include, without limitation, digital signal processor (DSP) hardware, ROM for storing software, random access memory (RAM), and non-volatile storage.

In the claims of the present specification, an element expressed as a means for performing a specific function may encompass any method of performing the particular function. Such an element may include a combination of circuit elements that perform a specific function, or any form of software, including firmware or microcode, combined with suitable circuits to perform software for performing the particular function.

The indications herein to “an embodiment” of the principles of the present disclosure and various modifications of such expressions mean that a particular feature, structure, characteristic, etc. in connection with this embodiment is included in at least one embodiment of the principles of the present disclosure. Thus, the expression “in an embodiment” and any other modifications disclosed throughout the present specification are not necessarily all referring to the same embodiment.

Throughout the present specification, the expression “at least one of A and B” is used to select only the first option A, only the second option B, both the first option A and the second option B. As an additional example, the expression “at least one of A, B, or C” may indicate only the first option A, only the second option B, only the third option C, both the first option A and the second option B, both the first option A and the third option C, both the second option B and the third option C, and all of the first option, the second option, and the third option. Even when more items are listed, it may be clearly interpreted by those of ordinary skill in the art.

So far, the preferred embodiments of the present disclosure have been described.

All embodiments and conditional examples disclosed throughout the present specification are described with the intent to help those of ordinary skill in the art to understand the principles and concepts of the present disclosure, and those of ordinary skill in the art will appreciate that the present disclosure may be embodied in modified forms without departing from the spirit and scope of the present disclosure. Therefore, the disclosed embodiments should be considered from an explanatory viewpoint rather than a limitative viewpoint. The scope of the present disclosure is shown in the claims rather than the foregoing description, and all differences within the scope equivalent thereto should be construed as falling within the present disclosure.

1. An operating method of an electronic device for managing a digital key, the operating method comprising:
receiving a response message to a request message for managing a shared digital key;
verifying information included in the received response message; and
managing the shared digital key based on the verified information.

2. The operating method of claim 1,
wherein the request message includes at least one of information about the shared digital key, request information, routing information, or a signature of a device transmitting the request message, and
wherein the response message includes at least one of information about the shared digital key, response information, routing information, or a signature of a device transmitting the response message.

3. The operating method of claim 2,
wherein the request information includes information requesting management of the shared digital key,
wherein the response information includes a result of the management of the shared digital key, and
wherein the management of the shared digital key includes at least one of revocation or updating of the shared digital key.

4. The operating method of claim 3,
wherein the revocation of the shared digital key comprises revocation of a permission to share the shared digital key, and
wherein the updating of the shared digital key comprises updating information about an expiration date of the shared digital key or permission to use the shared digital key.

5. The operating method of claim 3, further comprising transmitting information about the management of the shared digital key to a third electronic device.

6. The operating method of claim 3,
wherein the request message or the response message is transmitted through a communication method using near field communication (NFC) or a communication method using a hypertext transfer protocol (HTTP), and
wherein, when the communication method using the HTTP is used, the request message or the response message is transmitted through a first backend server or a second backend server.

7. The operating method of claim 6, further comprising:
generating the request message for managing the shared digital key; and
transmitting the generated request message to a target device.

8. The operating method of claim 6,
wherein, when the management of the shared digital key is triggered by the first backend server, the request message is generated by the first backend server,
wherein the generated request message is transmitted to the second backend server, and
wherein the response message is a response message to a request message changed based on the request message transmitted to the second backend server.

9. The operating method of claim 6,
wherein, when the management of the shared digital key is triggered by the second backend server, the request message is generated by the second backend server,
wherein the generated request message is transmitted to a target device, and
wherein the response message is a response message to the request message transmitted to the target device.

10. A method of managing a digital key of a target device, the method comprising:
verifying information included in a request message for managing a shared digital key;
generating a response message to the request message based on the verified information; and
transmitting the generated response message.

11. The method of claim 10, further comprising receiving the request message for managing the shared digital key,
wherein the request message includes at least one of information about the shared digital key, request information, routing information, or a signature of a device transmitting the request message, and
wherein the response message includes at least one of information about the shared digital key, response information, routing information, or a signature of a device transmitting the response message.

12. An electronic device comprising:
a communicator configured to receive a response message to a request message for managing a shared digital key; and
at least one processor configured to verity information included in the received response message and manage the shared digital key based on the verified information.

13. The electronic device of claim 12,
wherein the request message includes at least one of information about the shared digital key, request information, routing information, or a signature of a device transmitting the request message, and
wherein the response message includes at least one of information about the shared digital key, response information, routing information, or a signature of a device transmitting the response message.

14. The electronic device of claim 13,
wherein the request information includes information requesting management of the shared digital key,
wherein the response information includes a result of the management of the shared digital key, and
wherein the management of the shared digital key includes at least one of revocation or updating of the shared digital key

15. The electronic device of claim 14,
wherein the revocation of the shared digital key comprises revocation of a permission to share the shared digital key, and
wherein the updating of the shared digital key comprises updating information about an expiration date of the shared digital key or permission to use the shared digital key.
